(19) United States
(12) Patent Application Publication
(10) Pub. No.: US 2019/0114650 A1
(43) Pub. Date: Apr. 18, 2019

(54) SYSTEM AND METHOD OF GENERATING MESSAGES

(71) Applicant: The Toronto-Dominion Bank, Toronto (CA)

(72) Inventors: Jeffrey Aaron Ecker, Toronto (CA); Bryan Michael Gleeson, Bowmanville (CA); Igor Elkhinovich, Toronto (CA); Dmitri Rabinovich, Richmond Hill (CA); Adam Douglas McPhee, Waterloo (CA); Matta Wakim, Petersburg (CA); Kyryll Odobetskiy, Waterloo (CA); Arun Victor Jagga, Toronto (CA); John Jong-Suk Lee, Toronto (CA); Rakesh Thomas Jethwa, Toronto (CA)

(21) Appl. No.: 15/724,254

(22) Filed: Oct. 3, 2017

(51) Int. Cl. G06Q 30/02; G06F 16/906

(52) U.S. Cl. CPC G06Q 30/02; G06F 16/906

(57) ABSTRACT

A message generating system receives a data set comprising at least one data record. Each data record stores an attribute in association with first and second events. The system identifies the attributes associated with the data set, and generates a data cluster comprising the identified attributes and the associated data set. The system associates with each cluster an assessment rule that defines a relationship between the first and second events and includes a first coefficient and a second coefficient. For each cluster, the system determines for each identified attribute a probability of the relationship, weights the second coefficient with the probability, evaluates the assessment rule using the weighted second coefficient, and generates an evaluation scenario that includes at least one of the identified attributes and the outcome of the evaluation. The generator selects one of the scenarios based on the associated outcome.

### FIELD

This patent application relates to a system and method of generating and transmitting messages to targeted recipients.

### BACKGROUND

A website might install unique data items (“cookies”) in web browser caches in order to track the interests of the website's visitors. The website might also link the unique data items to user profiles that are stored on the web server to thereby offer up tailored advertisements or other messages to the website visitors. For this approach to be viable however, the web browser must be configured to accept the unique data items. Moreover, a website visitor might periodically clear the web browser cache of the unique data items, and thereby reduce the visitor's tracking history. Therefore, the efficiency of this message generating process is limited.

### SUMMARY

This patent application discloses a system and associated method that generates and transmits messages.

In accordance with a first aspect of this disclosure, there is provided a message generating system that includes at least one memory, a profile database, a data repository and at least one processor. The processor is in communication with the memory, the profile database and the data repository.

The profile database includes a plurality of consumer profiles. Each consumer profile is associated with a respective communications device. The data repository includes at least one data set each comprising at least one data record. Each data record stores at least one attribute value in association with a first event and a second event.

For each data set, the message generating system is configured to identify at least one of the attributes that are associated with the data set.

The message generating system is configured to generate a data cluster that includes the identified attribute value(s) and the associated data set, and is also configured to associate an assessment rule with the data cluster. Each assessment rule defines a relationship between the respective first event and the respective second event and includes a second coefficient associated with the respective second event.

For each data cluster, the message generating system is configured to (i) determine, for each said associated identified attribute value, a probability of occurrence of the relationship, (ii) weight the respective second coefficient with the probability, (iii) evaluate the associated assessment rule using the respective weighted second coefficient, and (iv) generate an evaluation scenario comprising at least one of the associated identified attribute values and an outcome of the evaluation of the associated assessment rule.

The message generating system is also configured to select one of the evaluation scenarios based on the associated outcome, select from the profile database a subset of the consumer profiles corresponding to the attribute value(s) of the selected one evaluation scenario, and transmit to each said communications device of the selected consumer profile subset a message that includes a respective incentive value specified by the respective assessment rule.

In accordance with a second aspect of this disclosure, there is provided a method of generating messages that involves a computer server receiving at least one data set each comprising at least one data record. Each data record stores at least one attribute value in association with a first event and a second event. For each data set, the computer server identifies at least one of the attribute values that are associated with the data set.

The computer server generates a data cluster that includes the identified attribute value(s) and the associated data set, and associates an assessment rule with each data cluster. Each assessment rule defines a relationship between the respective first event and the respective second event and includes a second coefficient associated with the respective second event.

For each data cluster, the computer server (i) determines, for each said associated identified attribute value, a probability of occurrence of the relationship, (ii) weights the respective second coefficient with the probability, (iii) evaluates the associated assessment rule using the respective weighted second coefficient, and (iv) generates an evaluation scenario comprising at least one of the associated identified attribute values and an outcome of the evaluation of the associated assessment rule.

The computer server selects one of the evaluation scenarios based on the associated outcome, and selects from a profile database of consumer profiles a subset of the consumer profiles corresponding to the attribute value(s) of the selected one outcome. Each consumer profile is associated with a respective communications device.

The computer server then transmits to each communications device associated with the selected consumer profile subset a message that includes a respective incentive value specified by the respective assessment rule.

In accordance with a third aspect of this disclosure, there is provided a computer-readable medium that stores comprising computer processing instructions for execution by at least one processor of a computer server. The processing instructions, when executed by the at least one processor, cause the computer server to receive at least one data set comprising at least one data record. Each data record stores at least one attribute value in association with a first event and a second event.

The processing instructions cause the processor to, for each data set, identify at least one of the attribute values that are associated with the data set. The processing instructions also cause the processor to generate a data cluster that includes the identified attribute value(s) and the associated data set.

The processing instructions cause the processor to associate an assessment rule with each data cluster. Each assessment rule defines a relationship between the respective first event and the respective second event and includes a second coefficient associated with the respective second event.

The processing instructions cause the processor to, for each data cluster, (i) determine, for each said associated identified attribute value, a probability of occurrence of the relationship, (ii) weight the respective second coefficient with the probability, (iii) evaluate the associated assessment rule using the respective weighted second coefficient, and (iv) generate an evaluation scenario comprising at least one of the associated identified attribute values and an outcome of the evaluation of the associated assessment rule.

The processing instructions also cause the processor to select one of the data clusters based on the associated outcome, and select from a profile database of consumer profiles a subset of the consumer profiles corresponding to the identified attribute value(s) of the selected one outcome. Each consumer profile is associated with a respective communications device.

The processing instructions also cause the processor to transmit to each communications device associated with the selected consumer profile subset a message that includes a respective incentive value specified by the respective assessment rule.

Since the message generating system generates each data cluster from a subset of the data records and a respective attribute value(s) that is associated with the subset of the data records, the message generating system generates a novel data structure and uses that novel data structure to realize an improved technological process.

Further, since the message generating system uses the data clusters to determine the probabilities of relationships between the events identified in the data records, and uses the probabilities to tailor messages to target markets, the message generating system makes more efficient use of the available data.

### BRIEF DESCRIPTION OF THE DRAWINGS

An exemplary message generating system and method of generating and transmitting messages will now be described, with reference to the accompanying drawings, in which:

FIG. 1 is a schematic view of a message generating/transmitting network; and

FIG. 2 is a schematic view of a sample message generating system; and

FIGS. 3a and 3b together are a flow chart that depicts a sample method of generating and transmitting messages.

### DETAILED DESCRIPTION

### Message Generating/Transmitting Network

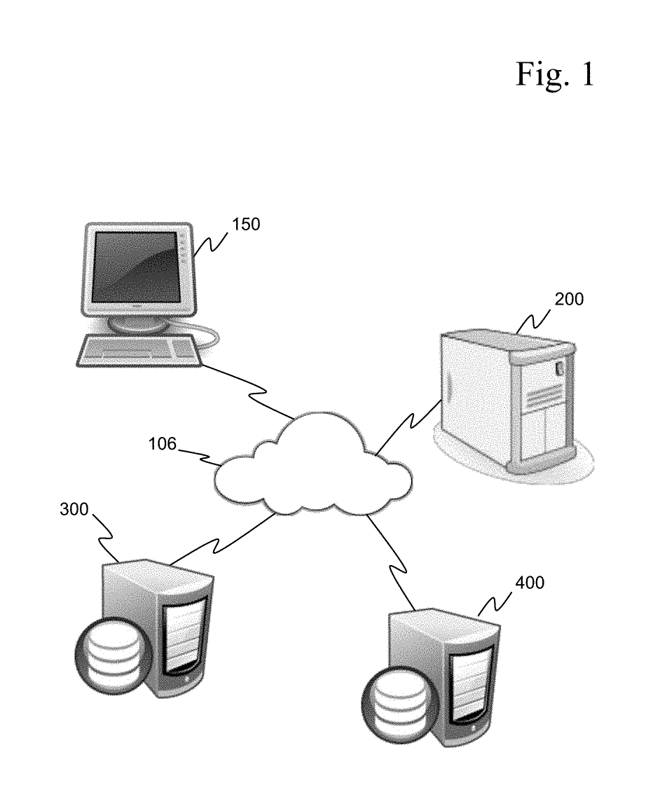

FIG. 1 is a schematic view of a message generating/transmitting network, denoted generally as 100. As shown, the message generating/transmitting network 100 includes a message generating system 200, a profile database server 300 and an incentive database server 400. The message generating/transmitting network 100 may also include a personal communications device 150.

The personal communications devices 150 may be configured to communicate with the message generating system 200 via a communications network 106. As non-limiting examples, one or more of the personal communications devices 150 may be implemented as a personal computer, a tablet computer, or a smartphone. Accordingly, the communications network 106 may comprise one or more wired network, one or more wireless networks, or a combination of wired and wireless networks.

The message generating system 200 may be implemented as a computer server. The message generating system 200 is configured to communicate with the personal communications devices 150, the profile database server 300 and the incentive database server 400 via the communications network 106.

The profile database server 300 is configured to communicate with the message generating system 200 via the communications network 106. The profile database server 300 may maintain a profile database that includes a plurality of consumer profiles each associated with a respective consumer.

Each consumer profile of the profile database may include contact information (e.g. postal address, e-mail address, phone number of a personal communications device 150), one or more attributes classes (e.g. sex, age demographic, country of residence), and attribute values for one or more of those attribute classes (e.g. “sex: male”, “age demographic: <30”, residence: Europe”) as associated with the respective consumer. As noted, the contact information may include particulars of the consumer's personal communications device 150. Therefore, each consumer profile may also be associated with a respective communications device 150.

The incentive database server 400 may be administered by a marketing agency or merchant, and is configured to communicate with the message generating system 200 via the communications network 106. The incentive database server 400 maintains an incentive database that includes a plurality of database records each comprising a respective marketing campaign template. Each marketing campaign template is associated with a respective marketing campaign, and identifies one or more incentives (e.g. price discount amounts, % price discounts) that may be applied to the purchase of a good or service in the respective marketing campaign. The marketing campaign templates may also specify the good/service to which the respective incentives may be applied.

Although the message generating/transmitting network 100 is shown comprising only a single personal communications device 150, a single message generating system 200, a single profile database server 300 and a single incentive database server 400, the message generating/transmitting network 100 may include a plurality of the personal communications devices 150, message generating systems 200, profile database servers 300 and incentive database servers 400.

Further, although the profile database server 300 and the incentive database server 400 are shown in FIG. 1 deployed on distinct database servers, the profile database and the incentive database may be deployed on a common database server. Alternately, one or both of the profile database and the incentive database may be integrated within the message generating system 200.

### Message Generating System

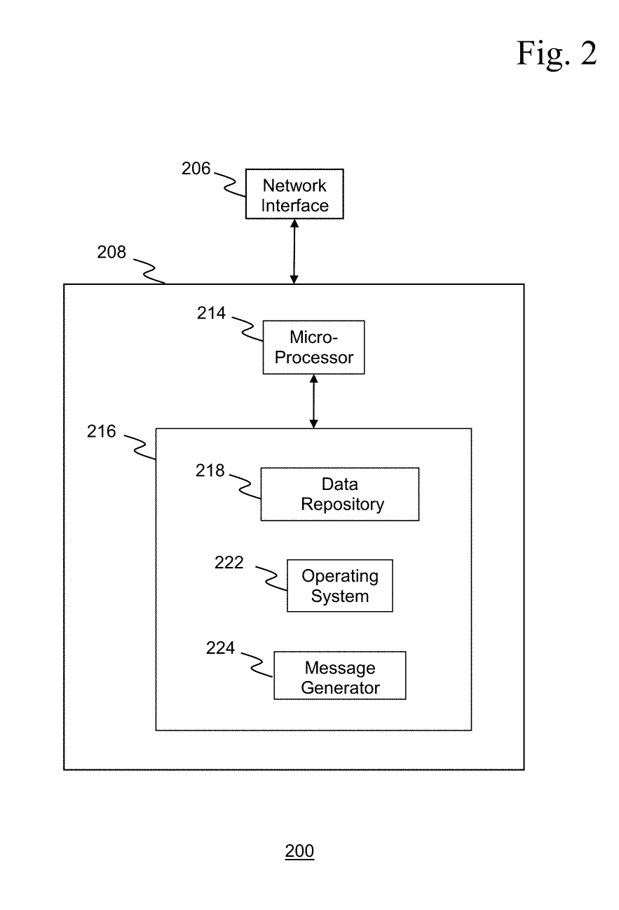

In the example shown in FIG. 2, the message generating system 200 includes a network interface 206 and a data processing system 208 that is coupled to the network interface 206. The network interface 206 interfaces the message generating system 200 with the communications network 106, and allows the message generating system 200 to communicate with the personal communications device(s) 150 and the database server(s) 300, 400.

The data processing system 208 may include one or more microprocessors 214, and one or more non-transient computer-readable media 216. As a non-limiting examples, the computer-readable media 216 may be provided as non-volatile electronic computer (e.g. FLASH) memories.

One or more of the computer-readable media 216 may store a database (data repository) 218 comprising at least one data set. Each data set may include one or more data records. Each data record summarizes a particular transaction that a consumer had completed with a merchant. Alternately, the data repository 218 may be deployed on the profile database server(s) 300 and/or the incentive database server(s) 400.

Each transaction summarized in the data repository 218 involves at least one event (e.g. purchase of particular good or service). Therefore, one or more of the data records of the data repository 218 may store, for each respective transaction, particulars (e.g. the class(es) of the goods/services purchased, the quantity of the goods/services purchased in each class) of the associated event(s), and one or more attribute values associated with the consumer involved in the transaction.

Preferably, one or more of the transactions summarized in the data repository 218 involves at least two events (e.g. purchase of two distinct classes of goods/services), and one or more of the data records of the data repository 218 store, for each respective transaction, particulars of the first event of the transaction, particulars of the second transaction event of the transaction, and one or more of the attributes values (e.g. “sex: male”, “age demographic: <30”, residence: Europe”) that are associated with the respective consumer.

The computer-readable media 216 may also store computer processing instructions which, when accessed and executed by the microprocessor(s) 214, implement an operating system 222 and a message generator 224.

The operating system 222 allows the message generating system 200 to communicate with the personal communications device(s) 150, the profile database server 300 and incentive database server 400 via the communications network 106.

As discussed, the data repository 218 stores at least one data set each comprising at least one data record. Each data record summarizes a transaction that may involve one or more events, and one or more of the data records of the data repository 218 may also store, for the respective transaction, one or more of the attributes values that are associated with the respective consumer. Therefore, the message generator 224 is configured to, for each data set, identify at least one of the attribute values that are associated with the data set. The message generator 224 is also configured to generate a data cluster that includes the identified attribute value(s) and the associated data set.

As discussed above, each marketing campaign template stored in the incentive database is associated with a respective marketing campaign, and identifies one or incentives that may be applied to the purchase of a good or service in the respective marketing campaign. Therefore, each marketing campaign template may include a campaign assessment rule that defines a relationship between a first event of the respective marketing campaign and a second event of the respective marketing campaign, and may also include an incentive value, and a second evaluation coefficient that is associated with the second event. One or more of the campaign assessment rules may also include a first evaluation coefficient that is associated with a first event of the respective marketing campaign. Each respective first evaluation coefficient may comprise a nominal value discounted by the respective incentive value (e.g. the first coefficient may be equal to the difference between the nominal value and the respective incentive value).

The message generator 224 is configured to associate a respective assessment rule with each data cluster. As discussed above, one or more of the data records of the data repository 218 may store, for the respective transaction, particulars of the first event of the transaction, and particulars of the second transaction event of the transaction. Therefore, the message generator 224 is configured to, for each data cluster, (i) determine, for each associated identified attribute value, a probability of occurrence of the relationship as defined in the associated assessment rule (e.g. the probability that, for consumers having one or more of the associated attribute value(s), the second event will occur if the first event occurred), (ii) weight the respective second coefficient with the probability, (iii) evaluate the associated assessment rule using the respective weighted second coefficient (and optionally the respective first coefficient), and (iv) generate an evaluation scenario comprising at least one of the associated identified attribute values and an outcome of the evaluation of the associated assessment rule.

The message generator 224 is also configured to select one of the evaluation scenarios based on the associated outcome. The message generator 224 might select the evaluation scenarios that have an evaluation outcome that is greater than the evaluation outcomes associated with other evaluation scenarios.

As discussed, the profile database may include a plurality of database sets each identifying one or more attributes values that are associated with the respective consumer. Therefore, the message generator 224 is configured to select from the profile database the subset(s) of the consumer profiles that correspond to the identified attribute value(s) of the selected evaluation scenario.

The message generator 224 is also configured to transmit to each said consumer of the selected consumer profile subset a message for completion of the respective first event. The message includes the respective incentive value defined in the assessment rule associated with the selected data cluster.

The consumer profiles may also include particulars of the consumers' respective communications device 150. Therefore, the message generator 224 may be configured to transmit the message to each communications device 150 associated with the selected consumer profile subset.

### Method of Generating and Transmitting Messages

As discussed, the message generating/transmitting network 100 implements a method of generating and transmitting messages.

As will be described in greater detail below, in one embodiment of the method, the message generating system 200 commences the method by receiving at least one data set that includes one or ore data records that are stored in the data repository 218. As discussed above, the data records stored in the data repository 218 each identify one or more events that are associated with a particular transaction that a consumer had completed with a merchant.

For example, a first data set may include data records that define transactions that are associated with the occurrence of Events A and B, a second data set may include data records that define transactions that are associated with the occurrence of Events B and C, and a third data set may include data records that define transactions that are associated with the occurrence of Events A and C.

For each data set, the message generating system 200 identifies at least one of the attribute values that are associated with the data set.

The message generating system 200 then generates a data cluster that includes the identified attribute value(s) and the associated data set. Therefore, if, for example, the message generating system 200 determined that the attribute values associated with a particular data set were “sex: male”, “age demographic: <30” and “residence: Europe”, the message generating system 200 might generate a data cluster that included “sex: male”, “age demographic: <30”, and “residence: Europe” as the applicable attribute values.

After generating the data clusters, the message generating system 200 associates an assessment rule with each data cluster. As discussed above, one or more of the data records of the data repository 218 may store, for the respective transaction, particulars of the first event of the transaction, and particulars of the second transaction event of the transaction. Therefore, each assessment rule may define a relationship between the first event and the second event of the transaction, and may include, for example, an incentive value and also a second evaluation coefficient that is associated with the second event of the respective transaction. One or more of the assessment rules may also include a first evaluation coefficient that is associated with the first event of the respective transaction. The respective first coefficient may be derived from a nominal value discounted by the respective incentive value (e.g. the first coefficient may be equal to the difference between the nominal value and the respective incentive value).

After associating assessment rules with the data clusters, for each data cluster the message generating system 200 then (i) determine, for each associated identified attribute value, a probability of occurrence of the relationship defined by the respective assessment rule (e.g. the probability that, for consumers having one or more of the associated attribute value(s), the second event will occur if the first event occurred), (ii) weights the respective second coefficient with the probability, (iii) evaluates the associated assessment rule using the respective weighted second coefficient (and optionally the respective first coefficient), and (iv) generates an evaluation scenario comprising at least one of the associated identified attribute values and an outcome of the evaluation of the associated assessment rule.

The message generating system 200 also selects one of the evaluation scenarios based on the associated outcome. The message generating system 200 might select evaluation scenarios that have an evaluation outcome that is greater than the evaluation outcomes associated with other evaluation scenarios.

As discussed, the profile database may include a plurality of database sets each identifying one or more attributes values that are associated with the respective consumer. Therefore, after selecting one of the data clusters, the message generating system 200 selects from the profile database the subset(s) of the consumer profiles that correspond to the identified attribute value(s) of the selected one scenario.

After selecting the subset(s) of consumer profiles, the message generating system 200 transmits to each said consumer of the selected consumer profile subset a message for completion of the respective first event. The message includes the respective incentive value defined in the assessment rule associated with the selected data cluster.

The consumer profiles may also include particulars of the consumers' respective communications device 150. Therefore, the message generating system 200 may transmit the message to each communications device 150 associated with the selected consumer profile subset.

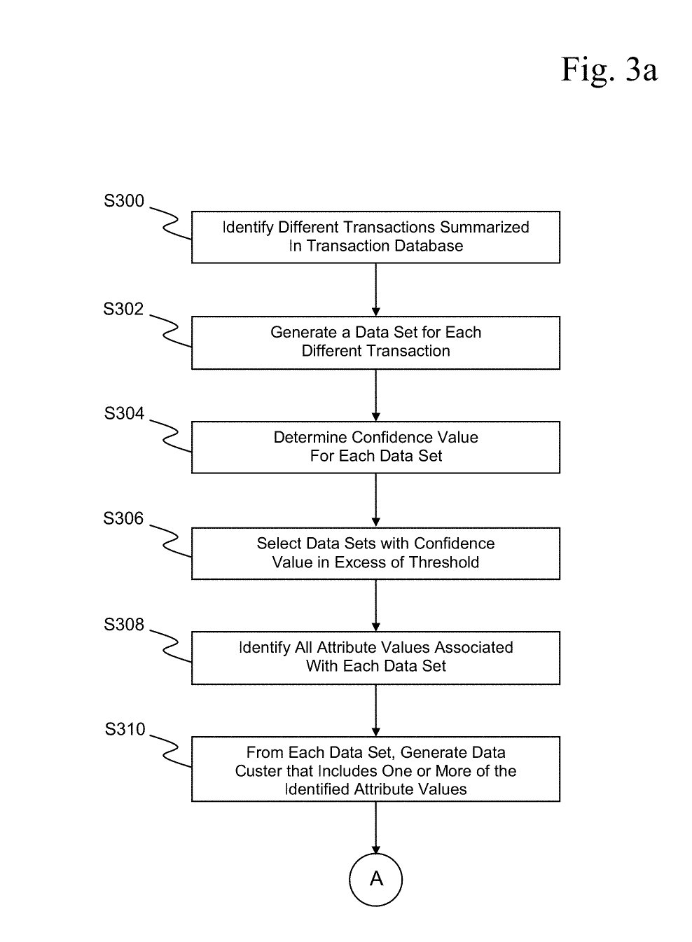

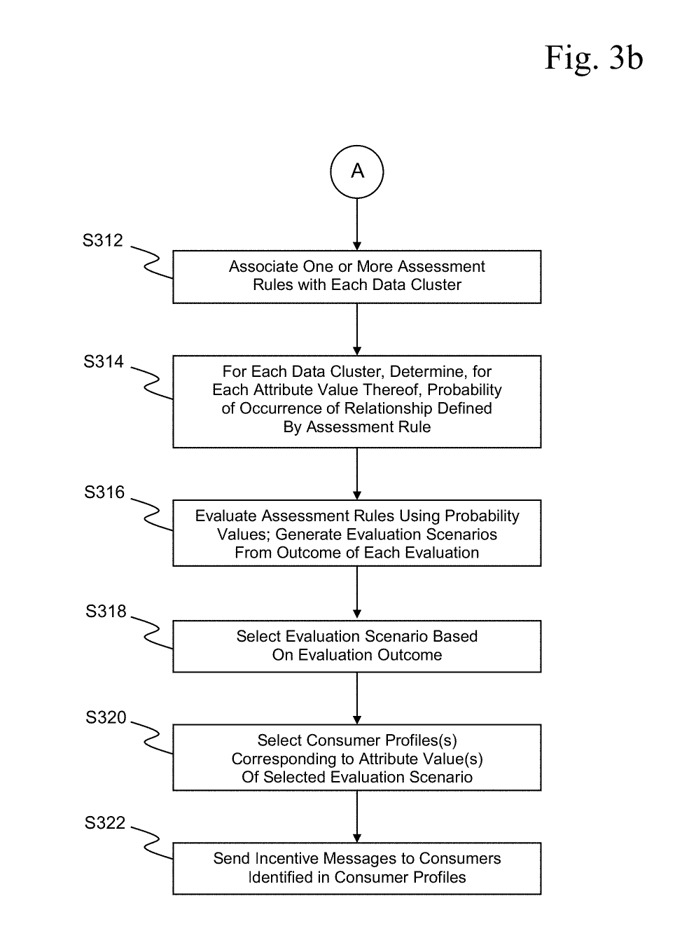

The method of generating and transmitting messages will now be discussed in detail with reference to the embodiment depicted in FIG. 3.

As discussed above, the data repository 218 may include one or more data sets. The merchant for whom this method of generating and transmitting messages was initiated may upload the data sets to the data repository 218. Alternately, a third party may have uploaded the data sets to the data repository 218. In the former situation, the data repository 218 might summarize transactions that all involved that merchant, whereas in the latter situation, the data repository 218 might summarize transactions that involved various merchants.

In the latter situation, the method may be initiated by the message generating system 200 selecting one or more data sets from the data records that are stored in the data repository 218. The message generating system 200 may select the data set(s) from the available data records using any suitable selection criteria or algorithm.

For example, the message generating system 200 may select the data set(s) based on a degree of confidence level that a relationship exists between the first event and the second event of one or more of “different” transactions. However, the merchant may wish to have a measure control over the selection of the data sets used in the method. Accordingly, in this variation, the merchant may provide the message generating system 200 with a predetermined “confidence threshold” (discussed below) to be used in the selection process, or the merchant may allow the message generating system 200 to use a default “confidence threshold” in the selection process.

The message generating system 200 may initiate the selection process by identifying the “different” transactions that are summarized in the data repository 218. Although each data record in the data repository 218 may be associated with a respective transaction completed by a consumer, and may include one or more attribute values that are associated with the respective consumer, in this context “different” transactions may be considered transactions that are characterized by event definitions that include two or more events, and each event definition is unique amongst all other event definitions in the data repository 218.

For example, if the data repository 218 stored a first plurality of data records that were all characterized by an event definition consisting of Event A and Event B, a second plurality of data records that were all characterized by an event definition consisting of Event B and Event C, and a third plurality of data records that were all characterized by an event definition consisting of Event A and Event C, then the transactions defined by the occurrence of Event A and Event B may constitute a first transaction, the transactions defined by the occurrence of Event B and Event C may constitute a second transaction, and the transactions defined by the occurrence of Event A and Event C may constitute a third transaction. However, each transaction characterized by the same event definition (e.g. Event A and Event B) would not constitute a different transaction, notwithstanding that all the transaction may have been completed by different consumers.

In the foregoing example, each event definition and each corresponding transaction was characterized by two events. However, as discussed, the event definitions may be characterized by more than two events. Therefore, for example, the data repository 218 might store a plurality of data records that are all characterized by an event definition consisting of Event A, Event B and Event C, in which case the corresponding transaction may be defined by the occurrence of Event A, Event B and Event C.

Therefore, in the embodiment of FIG. 3, at step S300 the message generating system 200 may identify the different transactions that are summarized in the data repository 218 by identifying the data records whose associated first and second events constitute an event definition that is unique amongst all the data records stored in the data repository 218. Alternately (or additionally), the message generating system 200 may identify the data records whose associated first, second and third (or more) events constitute an event definition that is unique amongst all the data records stored in the data repository 218.

At step S302, the message generating system 200 may generate data sets by, for each different data record, extracting from the data repository 218 all the data records that correspond to the respective (different) data record.

For example, if the transactions defined by the occurrence of Event A and Event B constitute a first transaction, the message generating system 200 may generate a first data set by extracting from the data repository 218 all the data records whose respective event definitions consist of Event A and Event B. If the transactions defined by the occurrence of Event B and Event C constitute a second transaction, the message generating system 200 may generate a second data set by extracting from the data repository 218 all the data records whose respective event definitions consist of Event B and Event C. If the transactions defined by the occurrence of Event A and Event C constitute a third transaction, the message generating system 200 may generate a third data set by extracting from the data repository 218 all the data records whose respective event definitions consist of Event A and Event C.

Similarly, if the transactions defined by the occurrence of Event A, Event B and Event C constitute a fourth transaction, the message generating system 200 may generate a fourth data set by extracting from the data repository 218 all the data records whose respective event definitions consist of Event A, Event B and Event C.

At step S304, the message generating system 200 may determine a respective “confidence value” for each data set. In this context, the “confidence value” for any one of the data sets is the level of confidence that a relationship exists between the respective first event and the respective second event.

Continuing with the foregoing examples, the “confidence value” for the data set defined by the occurrence of Event A and Event B may be the level of confidence that Event B will occur given the occurrence of Event A (hereinafter relationship “A→B”). The “confidence value” for the data set defined by the occurrence of Event B and Event C may be the level of confidence that Event C will occur given the occurrence of Event B (hereinafter relationship “B→C”). The “confidence value” for the data set defined by the occurrence of Event A and Event C may be the level of confidence that Event C will occur given the occurrence of Event A (hereinafter relationship “A→C”). Similarly, the “confidence value” for the data set defined by the occurrence of Event A, Even B and Event C may be the level of confidence that Event C will occur given the occurrence of Event A and Event B (hereinafter relationship “A+B→C”).

The message generating system 200 may determine the confidence level for each of the data sets based on, for example, the number of data records corresponding to the respective data set. For example, the message generating system 200 might determine that the confidence level for relationship A→B (e.g. the purchase of good/service B given the purchase of good/service A) was 85% if the data repository 218 included a total of 100 data records and 85 of those data records corresponded to the first transaction (occurrence of Event A and Event B).

The message generating system 200 might determine that the confidence level for relationship B→C (e.g. the purchase of good/service C given the purchase of good/service B) was 60% if the data repository 218 included 60 data records corresponding to the second transaction (occurrence of Event B and Event C), and might determine that the confidence level for relationship A→C (e.g. the purchase of good/service C given the purchase of good/service A) was 75% if the data repository 218 includes 75 data records corresponding to the third transaction (occurrence of Event A and Event C). The message generating system 200 might determine that the confidence level for relationship A+B∝C (e.g. the purchase of good/service C given the purchase of good/service A and good/service B) was 50% if the data repository 218 included 50 data records corresponding to the fourth transaction (occurrence of Event A, Event B and Event C).

At step S306, the message generating system 200 may determine, for each data set, whether the confidence value for the associated relationship exceeds the predetermined confidence threshold (a default value, or previously provided to the system 200 via a merchant, for example). The message generating system 200 may then select from all the data sets each data set whose respective confidence value exceeds the predetermined confidence threshold.

Continuing with the foregoing example, if the predetermined confidence threshold utilized by the message generating system 200 was 70%, and the message generating system 200 determined that the confidence value for relationship A→B was 85%, at step S306 the message generating system 200 might select the data set associated with the relationship A→B. Similarly, if the message generating system 200 determined that the confidence value for relationship A→C was 75%, at step S306 the message generating system 200 might also select the data set associated with the relationship A→C. Conversely, if the message generating system 200 determined that the confidence value for relationship B→C was 60% and the confidence value for relationship A+B→C was 50%, at step S306 the message generating system 200 might exclude from further consideration the data set associated with the relationship B→C and the data set associated with the relationship A+B→C.

However, if the predetermined confidence threshold utilized by the message generating system 200 was 80%, step S306 the message generating system 200 might select the data set associated with the relationship A→B, but might exclude from further consideration the data set associated with the relationship B→C, the data set associated with the relationship A→C, and the data set associated with the relationship A+B→C.

Thus far in this discussion, it has been assumed that the merchant for whom this method of generating and transmitting messages was initiated offers the goods/services defined in the aforementioned relationships. In one variation, the message generating system 200 includes a merchant database (not shown) that includes a plurality of records linking merchant IDs with the goods/services that are currently offered for sale by respective merchants. Accordingly, in this variation, the message generating system 200 may receive a merchant ID from the merchant at the outset of the method, and may exclude from consideration, step S306, all data sets that are associated with goods/services not offered for sale by the merchant.

After selecting one or more data sets, at step S308 the message generating system 200 identifies, for each selected data set, all the attribute values that are associated with the respective data set. At step S310, the message generating system 200 generates a data cluster that includes one or more of the identified attribute values and the associated data set.

For example, if, at step S306, the message generating system 200 selected the data set associated with the relationship A→B, and one or more of the data records of that data set included the attribute values “sex: male” and/or “age demographic: <30”, at step S310 the message generating system 200 might generate a data cluster that included “sex: male” and “age demographic: <30” as the applicable attribute values. In this example, the data cluster would also include all the data records that were associated with that data set and had any of the applicable attribute value(s).

If, at step S306, the message generating system 200 also selected the data set associated with the relationship A→C, and one or more of the data records of that data set included the attribute values “age demographic: 65+” and/or “residence: Europe”, at step S310 the message generating system 200 might generate a data cluster that included “age demographic: 65+” and “residence: Europe” as the applicable attribute values(s). In this example, each data cluster would also include all the data records that were associated with that data set and had the respective attribute values.

After generating the respective data clusters, the message generating system 200 associates an assessment rule with each data cluster.

As discussed above, the incentive database includes a plurality of marketing campaign templates, each identifying one or more incentives (e.g. price discount amounts, % price discounts) that may be applied to the purchase of a good or service during the respective marketing campaign. Each marketing campaign template may also define a relationship between a first event of the respective marketing campaign and a second event of the respective marketing campaign.

For example, the relationships defined by the marketing campaign templates may propose a particular profit margin on the sale of a product in class B and also propose a particular incentive on the sale of a product in class A. Therefore, each marketing campaign template may include an assessment rule that comprises an incentive value and also comprises a second evaluation coefficient that is associated with the second event (e.g. proposed profit margin on the sale of a product in class B). Further, one or more of the assessment rules may also include a first evaluation coefficient that is associated with the first event of the respective marketing campaign (e.g. nominal profile margin on the sale of a product in class A, discounted by the incentive value).

Therefore, at step S312 the message generating system 200 might associate one or more assessment rules with each data cluster by selecting from the incentive database one or more of the marketing campaign templates, and associating the respective assessment rule(s) with a respective one of the data clusters.

After associating assessment rules with the respective data clusters, the message generating system 200 evaluates each data cluster using the assessment rule(s) of the respective marketing campaign template. The message generating system 200 then selects one or more of the data clusters based on the outcome of the evaluations of the respective assessment rules.

As discussed above, the data records of the data repository 218 may store, for the respective transaction, particulars of the first event of the transaction, and particulars of the second transaction event of the transaction. Therefore, the message generating system 200 initiates the evaluation of each data cluster at step S314 by, for each data cluster, determining, for each said associated identified attribute value, a probability of occurrence of the relationship defined by the associated assessment rule(s) (e.g. the probability that, for consumers having one or more of the associated attribute value(s), the second event will occur if the first event occurred).

The message generating system 200 may determine the aforementioned probabilities by, for example, applying a binomial logistics regression model to the respective data clusters. The logistics regression model may define the dependent variable thereof as the occurrence of the respective data cluster relationship, and may define the independent variable thereof as the identified attribute value(s) associated with the data cluster.

Continuing with the foregoing example, if, at step S310, the message generating system 200 generated a data cluster that included the attribute values “sex: male” and “age demographic: <30”, and the relationship A→B (e.g. the purchase of a product in class B given the purchase of a product in class A), at step S314 the message generating system 200 might use logistics regression to fit (to the data records of the data cluster) the standard logistic function:

f(x)=1/(1+e^{-x}t),

where: x is the data cluster relationship,
t=U+V*(sex: male)+W*(age demographic: <30), and
U, V and W are constants (solved by optimizing f(x) for all t),
   and thereby determine the probability of the relationship A→B being true for consumers having the attribute values “sex: male” and/or “age demographic: <30” (i.e. the likelihood that consumers having one or more of those attributes would purchase a product in class B given the purchase of a product in class A).

Similarly, if, at step S310, the message generating system 200 generated a data cluster that included the attribute values “age demographic: 65+” and “residence: Europe” and the relationship A→C (e.g. the purchase of a product in class C given the purchase of a product in class A), at step S314 the message generating system 200 might use the standard logistic function to determine the probability of the relationship A→C being true for consumers having one or more of those attribute values (i.e. the likelihood that consumers have those attributes would purchase a product in class C given the purchase of a product in class A).

After calculating the probabilities for the relationships defined by the respective data clusters, at step S316 the message generating system 200 completes the evaluation of each data cluster by, for each data cluster, (i) weighting (multiplying) the respective second coefficient (of the associated assessment rule) with the probability, (ii) evaluating the associated assessment rule(s) using the respective weighted second coefficient (and optionally the respective first coefficient), and (iii) generating an evaluation scenario that includes at least one of the associated identified attribute values and the outcome of the evaluation of the associated assessment rule.

The message generating system 200 might use the following equation to evaluate the respective assessment rules:

Y=X1+P*X2,
where: Y is the outcome of the evaluation of the respective assessment rule,
X1 is the post discount profit margin (nominal profit margin—incentive amount) specified in the associated assessment rule for an incentivized sale of a product in class A,
X2 is the nominal profit margin specified in the associated assessment rule for a non-incentivized sale of a product in class B, and
P is the probability of the relationship A B being true for consumers having the specified attribute values.

Continuing with the foregoing example, if, at step S314, the message generating system 200 determined that the probability of the relationship A→B being true was (a) 25% for consumers having the attribute value “sex: male”, (b) 40% for consumers having the attribute value “age demographic: <30”, and (c) 70% for consumers having the attribute values “sex: male” and “age demographic: <30”, at step S316 the message generating system 200 might use each of these probability values in the respective assessments.

Further, if the nominal profit margin on the sale of a product in class A was $3, and the associated assessment rule proposed that the nominal profit margin on the sale of a product in class B would be $5, and also proposed that the incentive amount for the sale of a product in class A would $1, at step S316 the message generating system 200 might generate the following evaluation scenario outcomes:
Y=(3−1)+(0.25*5)=3.25 (for the scenario defined by the relationship A→B and consumers having the attribute value “sex: male”),
Y=(3−1)+(0.40*5)=4.0 (for the scenario defined by the relationship A→B and consumers having the attribute value “age demographic: <30”), and
Y=(3−1)+(0.70*5)=5.5 (for the scenario defined by the relationship A→B and consumers having the attribute values “sex: male” and “age demographic: <30”).

Similarly, if, at step S314, the message generating system 200 determined that the probability of the relationship A→C being true was (a) 30% for consumers having the attribute values “age demographic: 65+” and “residence: Europe”, (b) 55% for consumers having the attribute value “age demographic: 65+”, and (c) 60% for consumers having the attribute value “residence: Europe”, the message generating system 200 might use each of these probability values in the respective assessments.

Further, if the associated assessment rule proposed that the nominal profit margin on the sale of product C would be $4, and also proposed that the incentive amount for the sale of a product in class A would $0.50, at step S316 the message generating system 200 might also generate the following evaluation scenario outcomes:
Y=(3−0.5)+(0.30*4)=3.7 (for the scenario defined by the relationship A→C and consumers having the attribute values “age demographic: 65+” and “residence: Europe”),
Y=(3−0.5)+(0.55*4)=4.7 (for the scenario defined by the relationship A C and consumers having the attribute value “age demographic: 65+”), and
Y=(3−0.5)+(0.60*4)=4.9 (for the scenario defined by the relationship A C and consumers having the attribute value “residence: Europe”).

As discussed above, the message generating system 200 might associate more than one assessment rule with a particular data cluster. Therefore, if another assessment rule proposed that the nominal profit margin on the sale of product C would be $4.90 (an increase of $0.90), and also proposed that the incentive amount for the sale of a product in class A would $1.00 (an increase of $0.50), at step S316 the message generating system 200 might also generate the following evaluation scenario outcomes:
Y=(3−1)+(0.30*4.9)=3.5 (for the scenario defined by the relationship A C and consumers having the attribute values “age demographic: 65+” and “residence: Europe”),
Y=(3−1)+(0.55*4.9)=4.7 (for the scenario defined by the relationship A C and consumers having the attribute value “age demographic: 65+”), and
Y=(3−1)+(0.60*4.9)=4.9 (for the scenario defined by the relationship A C and consumers having the attribute value “residence: Europe”).

At step S318 the message generating system 200 might select an evaluation scenario that realized an evaluation outcome that is greater than the evaluation outcomes realized from all other evaluation scenarios. Therefore, continuing with the foregoing examples, at step S318 the message generating system 200 might select the evaluation scenario characterized by a nominal profit margin on the sale of a product in class B of $5, and an incentive amount on the sale of a product in class A of $1.00, for all consumers having the attribute values “sex: male” and “age demographic: <30” (evaluation outcome Y=5.5).

Alternately (or additionally), the message generating system 200 might select the evaluation scenario (associated with a particular relationship) that realized an evaluation outcome that is greater than the evaluation outcomes realized from all other evaluation scenarios (associated with that particular relationship). Therefore, continuing with the foregoing examples, at step S318 the message generating system 200 might also select the evaluation scenarios characterized by (i) a nominal profit margin on a product in class C of $4, and an incentive amount on a product in class A of $0.50, and (ii) a nominal profit margin on a product in class C of $4.90 and an incentive amount on a product in class A of $1.00, for all consumers having the attribute value “residence: Europe” (evaluation outcome Y=4.9).

As discussed above, each consumer profile of the profile database may include contact information, and attribute values for one or more attribute classes that are associated with the respective consumer. At step S320, the message generating system 200 selects from the profile database a subset of the consumer profiles that have an attribute value corresponding to the attribute value of the selected evaluation scenario(s).

At step S322, the message generating system 200 generates a message, and sends the message to each consumer that is identified in the selected consumer profile subset. The message is intended to incentivize the respective consumer to complete the first event specified in the marketing campaign.

The message generating system 200 may generate the message from the marketing campaign template that is associated with the data cluster from which the evaluation scenario was selected. Therefore, the message includes the incentive value that was specified in the associated marketing campaign.

Continuing with the foregoing examples, the message generating system 200 might transmit to consumers having the attribute values “sex: male” and “age demographic: <30” a message offering a discount of $1 on the purchase of a product in class A. As discussed, the message generating system 200 determined that the probability of a consumer purchasing a product in class B having purchased a product in class A was 70% for consumers having these attribute values.

The message generating system 200 might also transmit to consumers having the attribute value “residence: Europe” a message offering a discount of $0.5 on the purchase of a product in class A. As discussed, the message generating system 200 determined that the probability of a consumer purchasing a product in class C having purchased a product in class A was 60% for consumers having this attribute value.

The message generating system 200 may use the contact information obtained from the consumer profile subset to transmit the message to the respective consumers. Therefore, depending upon each consumer's respective contact information, the message generating system 200 may transmit the messages to the respective consumers via a postal service, or to the consumers' respective personal communications devices 150 via the communications network 106.

1. A message generating system comprising:
at least one memory;
a data repository comprising at least one data set, each said at least one data set comprising at least one data record, each said data record storing an attribute value in association with a first event and a second event;
a profile database comprising a plurality of consumer profiles each associated with a respective communications device; and
at least one processor in communication with the at least one memory, the data repository and the profile database, the at least one memory storing computer processing instructions which, when accessed by the at least one processor, configure the at least one processor to:
for said at least one data set, identify at least one of the attribute values associated with said at least one data set;
generate a data cluster comprising said at least one identified attribute value and the associated at least one data set;
associate an assessment rule with each said data cluster, each said assessment rule defining a relationship between the respective first event and the respective second event and comprising a second coefficient associated with the respective second event;
for each said data cluster, (i) determine, for said associated identified attribute values, a probability of occurrence of the relationship, (ii) weight the respective second coefficient with the probability, (iii) evaluate the associated assessment rule using the respective weighted second coefficient, and (iv) generate an evaluation scenario comprising at least one of said associated identified attribute values and an outcome of the evaluation of the associated assessment rule;
select one of the evaluation scenarios based on the associated outcome;
select from the profile database a subset of the consumer profiles corresponding to said identified attribute values of the selected one evaluation scenario; and
transmit to each said communications device of the selected consumer profile subset a message comprising a respective incentive value specified by the respective assessment rule.

2. The message generating system according to claim 1, wherein the computer processing instructions configure the at least one processor to determine the probability of occurrence of the relationship by applying a binomial logistics regression model to each said data cluster, wherein a dependent variable for the binomial logistics regression model is the occurrence of the respective relationship, and an independent variable for the binomial logistics regression model comprises the identified attribute values associated with said data cluster.

3. The message generating system according to claim 2, wherein each said first event comprises a purchase of a first product, each said second event comprise a purchase of a second product, and the computer processing instructions configure the at least one processor to use the binomial logistics regression model to determine a likelihood of the purchase of the respective second product given the purchase of the respective first product.

4. The message generating system according to claim 3, wherein the assessment rule includes a first coefficient associated with the purchase of the first product, each said first coefficient comprises a nominal profit margin discounted by the respective incentive value, and each said second coefficient comprises a profit margin associated with the purchase of the respective second product.

5. The message generating system according to claim 1, wherein the computer processing instructions configure the at least one processor to confirm that the outcome of the evaluation of the assessment rule associated with the selected one data cluster is greater than the outcome of the evaluation of the assessment rule associated with other ones of data clusters.

6. The message generating system according to claim 1, wherein the computer processing instructions configure the at least one processor to, prior to identifying said at least one attribute values:
receive a plurality of the data records;
identify different ones of the data records in the plurality of data records;
for each said different data record, determine a respective confidence value for each said different one data record, each said confidence value defining a respective confidence value of the relationship associated with the respective first event and the respective second event; and
determine that the confidence value of the relationship associated with the least one data set exceeds a predetermined threshold.

7. The message generating system according to claim 6, wherein the computer processing instructions configure the at least one processor to determine the respective confidence value from an occurrence of the respective different one data record in the plurality of data records.

8. A method of generating messages, the method comprising a computer server:
receiving at least one data set, each said at least one data set comprising at least one data record, each said data record storing an attribute value in association with a first event and a second event;
for each said at least one data set, identifying at least one of the attribute values associated with said at least one data set and generating a data cluster comprising said at least one identified attribute value and the associated at least one data set;
associating an assessment rule with each said data cluster, each said assessment rule defining a relationship between the respective first event and the respective second event and comprising a second coefficient associated with the respective second event;
for each said data cluster, (i) determining, for said associated identified attribute values, a probability of occurrence of the relationship, (ii) weighting the respective second coefficient with the probability, (iii) evaluating the associated assessment rule using the respective weighted second coefficient, and (iv) generating an evaluation scenario comprising at least one of said associated identified attribute values and an outcome of the evaluation of the associated assessment rule; and
selecting one of the evaluation scenarios based on the associated outcome, and selecting from a profile database of consumer profiles a subset of the consumer profiles corresponding to said identified attribute values of the selected one evaluation scenario, each said consumer profile being associated with a respective communications device; and
transmitting to each said communications device of the selected consumer profile subset a message comprising a respective incentive value specified by the respective assessment rule.

9. The method according to claim 8, wherein the determining a probability of occurrence of a relationship comprises applying a binomial logistics regression model to each said data cluster, and wherein a dependent variable for the binomial logistics regression model is the occurrence of the respective relationship, and an independent variable for the binomial logistics regression model comprises the identified attribute values associated with said data cluster.

10. The method according to claim 9, wherein each said first event comprises a purchase of a first product, each said second event comprise a purchase of a second product, and the applying a binomial logistics regression model comprises determining a likelihood of the purchase of the respective second product given the purchase of the respective first product.

11. The method according to claim 8, wherein the selecting one of the data clusters comprises confirming that the outcome of the evaluation of the assessment rule associated with the selected one data cluster is greater than the outcome of the evaluation of the assessment rule associated with other ones of data clusters.

12. The method according to claim 8, wherein the receiving at least one data set comprises:
receiving a plurality of the data records;
identifying different ones of the data records in the plurality of data records;
for each said different data record, determining a respective confidence value for each said different one data record, each said confidence value defining a respective confidence value of a relationship associated with the respective first event and the respective second event; and
determining that the confidence value of the relationship associated with the least one data set exceeds a predetermined threshold.

13. The method according to claim 12, wherein the determining a respective confidence value comprises determining the respective confidence value from an occurrence of the respective different one data record in the plurality of data records.

14. A computer-readable medium comprising computer processing instructions stored thereon for execution by at least one processor of a computer server, the computer processing instructions, when executed by the at least one processor causing the computer server to:
receive at least one data set, each said at least one data set comprising at least one data record, each said data record storing an attribute value in association with a first event and a second event;
for each said at least one data set identify at least one of the attribute values associated with said at least one data set, and generate a data cluster comprising said at least one identified attribute value and the associated at least one data set;
associate an assessment rule with each said data cluster, each said assessment rule defining a relationship between the respective first event and the respective second event and comprising a second coefficient associated with the respective second event;
for each said data cluster, (i) determine, for said associated identified attribute values, a probability of occurrence of the relationship, (ii) weight the respective second coefficient with the probability, (iii) evaluate the associated assessment rule using the respective weighted second coefficient, and (iv) generate an evaluation scenario comprising at least one of said associated identified attribute values and an outcome of the evaluation of the associated assessment rule; and
select one of the evaluation scenarios based on the associated outcome, and select from a profile database of consumer profiles a subset of the consumer profiles corresponding to said identified attribute values of the selected one evaluation scenario, each said consumer profile being associated with a respective communications device; and
transmit to each said communications device associated with the selected consumer profile subset a message comprising a respective incentive value specified by the respective assessment rule.

15. The computer-readable medium according to claim 14, wherein the computer processing instructions cause the computer server to apply a binomial logistics regression model to each said data cluster and determine the probability of occurrence of the relationship from the binomial logistics regression model, wherein a dependent variable for the binomial logistics regression model is the occurrence of the respective relationship, and an independent variable for the binomial logistics regression model comprises the identified attribute values associated with said data cluster.

16. The computer-readable medium according to claim 15, wherein each said first event comprises a purchase of a first product, each said second event comprise a purchase of a second product, and the computer processing instructions cause the computer server to use the binomial logistics regression model to determine a likelihood of the purchase of the respective second product given the purchase of the respective first product.

17. The computer-readable medium according to claim 16, wherein the assessment rule includes a first coefficient associated with the purchase of the first product, each said first coefficient comprises a nominal profit margin discounted by the respective incentive value, and each said second coefficient comprises a profit margin associated with the purchase of the respective second product.

18. The computer-readable medium according to claim 14, wherein the computer processing instructions cause the computer server to confirm that the outcome of the evaluation of the assessment rule associated with the selected one data cluster is greater than the outcome of the evaluation of the assessment rule associated with other ones of data clusters.

19. The computer-readable medium according to claim 14, wherein the computer processing instructions cause the computer server to, prior to identifying said at least one attribute values:
receive a plurality of the data records;
identify different ones of the data records in the plurality of data records;
for each said different data record, determine a respective confidence value for each said different one data record, each said confidence value defining a respective confidence value of a relationship associated with the respective first event and the respective second event; and
determine that the confidence value of the relationship associated with the least one data set exceeds a predetermined threshold.

20. The computer-readable medium according to claim 19, wherein the computer processing instructions cause the computer server to determine the respective confidence value from an occurrence of the respective different one data record in the plurality of data records.
